(19) United States
(12) Patent Application Publication
(10) Pub. No.: US 2016/0250939 A1
(43) Pub. Date: Sep. 1, 2016

(54) POWER LINE COMMUNICATION CABLE, AND ELECTRIC VEHICLE CHARGING SYSTEM AND ELECTRIC VEHICLE APPLYING THE SAME

(71) Applicant: LG INNOTEK CO., LTD., Seoul (KR)

(72) Inventor: Kwang Seob SHIN, Seoul (KR)

(21) Appl. No.: 15/019,361

(22) Filed: Feb. 9, 2016

(30) Foreign Application Priority Data
Feb. 26, 2015 (KR) 10-2015-0027225

(51) Int. Cl. B60L 11/18; H02J 7/00

(52) U.S. Cl. CPC B60L 11/1816; H02J 7/0042

(57) ABSTRACT

A power line communication cable is formed in a spiral shape including a single-stranded PLC signal transmitting line transmitting a PLC signal and a ground line being mutually intercrossed, thereby to enhance signal quality of power line communication.

### CROSS-REFERENCE TO RELATED APPLICATIONS

The present application is based on, and claims priority from the Korean Patent Application Number 10-2015-0027225 filed on Feb. 26, 2015, the entire content of which is incorporated by reference herein in its entirety.

### BACKGROUND OF THE INVENTION

1. Field of the Invention

The present disclosure relates to a power line communication cable. More particularly, the present disclosure relates to a power line communication cable capable of preventing signal distortion when charging an electric vehicle, and to an electric vehicle charging system and an electric vehicle applying the power line communication cable.

2. Description of Related Art

As problems of environmental pollution and energy exhaustion are raised, researches for energy sources substitutable for conventional fossil fuels are actively being conducted, of which one field is an electric vehicle. However, an infrastructure for charging the electric vehicles is required to be completely equipped, in order for the electric vehicles to successfully land on the global vehicle market.

In general, an electric vehicle charging system may be categorized roughly by charging method, connecting method, and communicating and controlling method. Furthermore, the charging method may be categorized into a conductive charging method, an inductive charging method, and a battery swapping method. Electrical connecting devices such as a connector (corresponding to a lubricator) and an inlet (corresponding to a fuel hole of a vehicle) are provided, and the electrical connecting devices may be categorized into a single and three phase AC (Alternating Current) type, a dedicated DC (Direct Current) type, and a combo type including both of AC and DC types. The communicating method may be categorized roughly into a CAN (Controller Area Network) communication method generally used m Japan and a PLC (Power Line Communication) method preferred in the U.S. and Europe.

In particular, in order to support stable charging and various additional services, a communication system between the electric vehicle and the charging system may be a key issue. At present, the ISO (International Standard Organization) and the IEC (International Electrotechnical Commission) have selected the PLC (Power Line Communication) as a communication technology for electric vehicle charging system, and the standardization of ISO/IEC 15118 ‘Vehicle to grid communication interface’ is currently underway as well.

The PLC is a communication method using an electric power line. The PLC is advantageous in that the communication is available in any place where the electric power is supplied, because the electric power line is used as a communication line with an AC signal in use as transmission media.

In the PLC, it is preferable to use a coaxial cable as a signal line from a perspective of communication performance. However, the cost may be excessively increased when the coaxial cable is used as the signal line. Therefore, it is required to develop a power line communication cable that is using a low-priced single wire as well as capable of stably performing power lime communication without signal distortion.

### SUMMARY

The technical challenge which the present disclosure intends to achieve is, to provide a power line communication cable that is able to prevent data loss and signal distortion during the power line communication.

In a general aspect, there is provided a power line communication cable for charging an electric vehicle, the power line communication cable comprising: a PLC signal transmitting line connected to a controller generating a control signal for receiving power; and a ground line connected to a ground, wherein the PLC signal transmitting line and the ground line respectively may include a single stranded wire, where the PLC signal transmitting line and the ground line may be formed in a spiral shape by being mutually intercrossed.

In some exemplary embodiments, the PLC signal transmitting line may be made of a copper material.

In some exemplary embodiments, the power line communication cable transmits a control signal within a bandwidth of 1.8 MHz to 28 MHz.

In another general aspect, there is provided an electric vehicle charging system supplying electric power to an electric vehicle, the electric vehicle charging system comprising: a power line supplying electric power required to charge the electric vehicle; and a PLC line transmitting a signal for controlling charging of the electric vehicle, wherein the PLC line may include a single-stranded PLC signal transmitting line transmitting a PLC signal and a ground line, where the PLC signal transmitting line and the ground line may be formed in a spiral shape by being mutually intercrossed.

In some exemplary embodiments, the PLC line may be made of a copper material.

In still another general aspect, there is provided an electric vehicle supplied with electric power from an electric vehicle charging system, the electric vehicle comprising: a power line port supplied with electric power required to charge the electric vehicle from the electric power charging system; and a PLC line port receiving a signal for controlling charging of the electric vehicle, wherein the PLC line port may be connected to a power line communication cable formed in a spiral shape including a single-stranded PLC signal transmitting line and a ground line being mutually intercrossed.

In some exemplary embodiments, the PLC line may be made of a copper material.

The power line communication cable according to an exemplary embodiment of the present disclosure may prevent loss or distortion of signals during the power line communication, thereby to enhance quality of signals.

In particular, the power line communication cable according to an exemplary embodiment of the present disclosure may prevent loss of signals at a reception terminal of the electric vehicle's side, during charging of the electric vehicle. Thereby, the quality of signals can be significantly improved.

### BRIEF DESCRIPTION OF DRAWINGS

FIG. 1 is a view illustrating a power line communication cable, used in charging an electric vehicle, according to an exemplary embodiment of the present disclosure.

FIG. 2 is a view illustrating an example of an electric vehicle charging system associated with an exemplary embodiment of the present disclosure.

FIG. 3 is a block diagram illustrating an exemplary structure where an electric vehicle and an electric vehicle charging system according to an exemplary embodiment of the present disclosure are connected via a cable assembly.

FIG. 4 is a view illustrating an example of PLC signal transmission according to the DIN 70121 standard.

FIGS. 5A and 5B are views illustrating a result of signal loss measurement on a PLC signal transmitting line.

### DETAILED DESCRIPTION

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein. Rather, the described aspect is intended to embrace all such alterations, modifications, variations, and equivalents that fall within the scope and novel idea of the present disclosure.

Hereinafter, exemplary embodiments of the present disclosure will be described in detail with reference to the enclosed drawings.

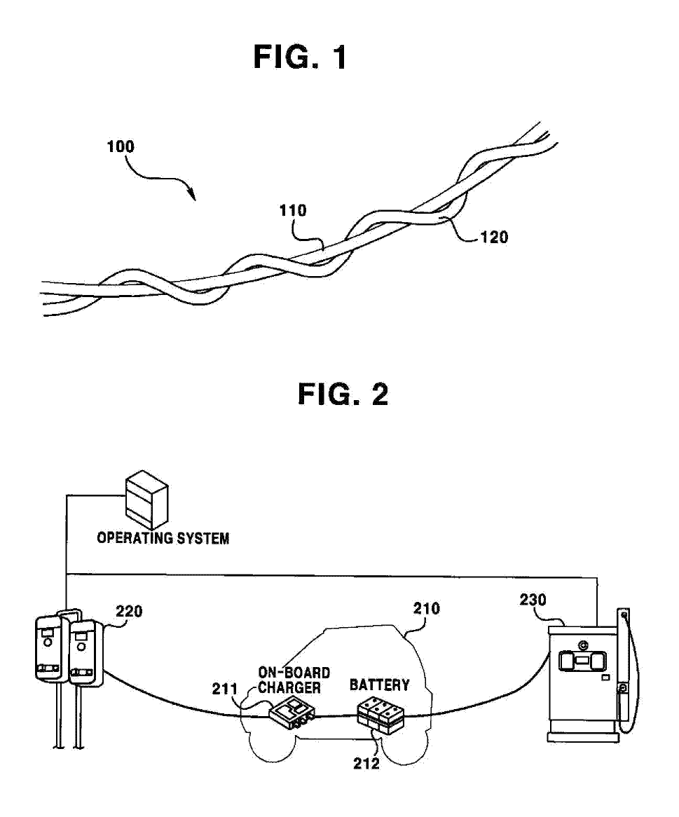

FIG. 1 is a view illustrating a power line communication cable (100), used in charging an electric vehicle, according to an exemplary embodiment of the present disclosure.

Referring to FIG. 1, the power line communication cable (100) may include a PLC signal transferring line (110) and a ground line (120), where the PLC signal transferring line (110) and the ground line (120) may be twisted in a spiral shape by being intercrossed with each other.

Various types of lines may be used as the PLC signal transferring line, depending on the frequency in use. Various standards and corresponding bandwidths may be applied to the product in use The HPGP (HomePlug GreenPHY) standard may be applied to the power line communication for charging the electric vehicle, where a bandwidth of 1.8 MHz˜28 MHz may be used.

When an electric vehicle is fast charged, the power line communication may control matters such as current charging status between the electric vehicle supply equipment and the electric vehicle, accounting, emergency, etc.

The conventional PLC signal line is formed of a single wire, which has a disadvantage in that loss of signals much occurs in the conventional PLC signal line. The PLC signal transmitting line (110) according to an exemplary embodiment may enhance the quality of signals, where the single-wired PLC signal transmitting line (110) may be twisted with the ground line (120). In particular, the transmission level of signals may be maintained stably without any distortion. The PLC signal transmitting line (110) may be made of any material. In some exemplary embodiments of the present disclosure, the PLC signal transmitting line (110) may be made of a copper material.

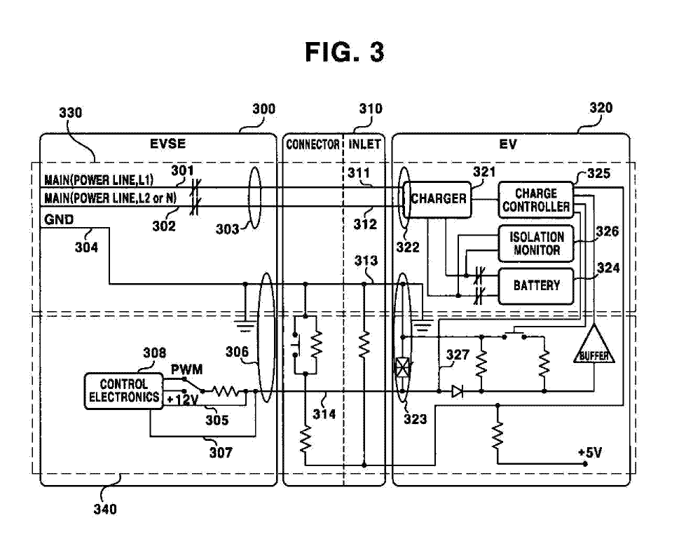

FIG. 2 is a view illustrating an example of an electric vehicle charging system associated with an exemplary embodiment of the present disclosure.

Referring to FIG, 2, a charging infrastructure for an electric vehicle (210) may be generally categorized into a slow charging stand (220) and a fast charging stand (230). The slow charging stand (220) may use a single-phase AC (Alternating Current) power source, and the fast charging stand (230) may receive a high-voltage power source from the underground and convert the power source to DC (Direct Current) electricity for supplying to the electric vehicle.

The slow charging stand (220) supplying AC electric power is a device to supply the electric vehicle (210) with AC electric power by being supplied with electricity from an AC power source. The electric vehicle (210) may convert the AC electric power supplied from the slow charging stand (220) via an OBC (On-Board Charger; 211), to charge a battery (212) with electricity.

Meanwhile, the fast charging stand (230) supplying AC electric power is supplied with electricity from an AC power source, converts the AC electricity to DC electricity, and supplies the DC electricity to the electric vehicle (210). Here, the supplied DC electricity may be directly charged in the battery (212) without any further conversion.

Although it is not illustrated in FIG. 2, the slow charging stand (220) and the fast charging stand (230) may include a device to input/output charging information required by the user, a control system to control the charging process, a smart meter device to read amount of electric power charged/discharged, a communication device to communicate with an operating system that operates the charging system and bills an account therefor, and a communication device to control charging of the electric vehicle.

That is the electric vehicle charging system may include a high-voltage/high-current interface for supplying electric power and a communication interface for charging control.

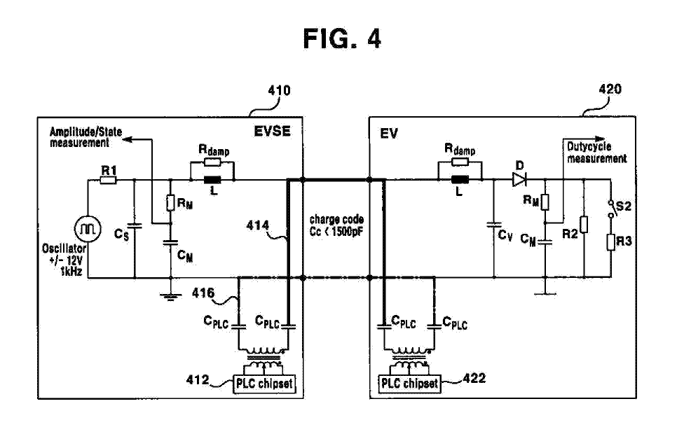

FIG. 3 is a block diagram illustrating an exemplary structure where an electric vehicle and an electric vehicle charging system according to an exemplary embodiment of the present disclosure are connected via a cable assembly. FIG. 3 is provided in order to describe an interface for transmitting/receiving a PLC signal between the electric vehicle and the electric vehicle charging system.

Referring to FIG, 3, the electric vehicle charging system (300) according to an exemplary embodiment of the present disclosure may be connected to an electric vehicle (320) via a cable assembly (310).

Electric power transmitting lines (301, 302) of the electric vehicle charging system (300) may be coupled to power lines (311, 312) of the cable assembly (310). In addition, the power lines (311, 312) of the cable assembly (310) may be coupled to a charger (321) of the electric vehicle (320) to be used in electric power transmission and power line signal transmission.

In a case where the power line signal is coupled using the electric power transmitting line, the PLC signal transmitting line may include PLC signal coupling interface (303, 322).

When the power line signal is coupled, the PLC signal transmitting line (307) may be coupled behind a power switch, or alternatively, may be coupled in front of the power switch by connecting front and rear of the power switch with a bypass filter.

Alternatively, in a case where the PLC signal is transmitted/received using a control pilot line without any separate PLC signal transmitting line, a ground terminal (304) and a control pilot line (305) of the electric vehicle charging system (300) may be coupled to a ground terminal (313) and a control pilot line (314) of the cable assembly (310), thereby to be connected inside of the electric vehicle. In a case where the power line signal is coupled using the control pilot line, the electric vehicle charging system (300) and the electric vehicle (320) may include the cable assembly (310) and the PLC signal coupling interface (306, 323).

Although it is not illustrated in FIG. 3, an inductive coupling may be used in order to prevent PWM 12V waveform loss or signal distortion, when the PLC signal is coupled to a control pilot line.

Meanwhile, the electric vehicle (320) may be charged by transmitting the electric power supplied from the electric power transmitting line (311, 312) to the battery (324) via the charger (321). In addition, the electric vehicle (320) may include a charge controller (325) and an isolation monitor (326) in order to monitor and control the charging process. The charge controller (325) may be controlled via the PLC signal transmitting line (327).

That is, in FIG. 3, the upper portion (330) may refer to a portion to transmit electric power for charging the electric vehicle, and the lower portion (340) may refer to a portion to transmit a PLC signal for charge control.

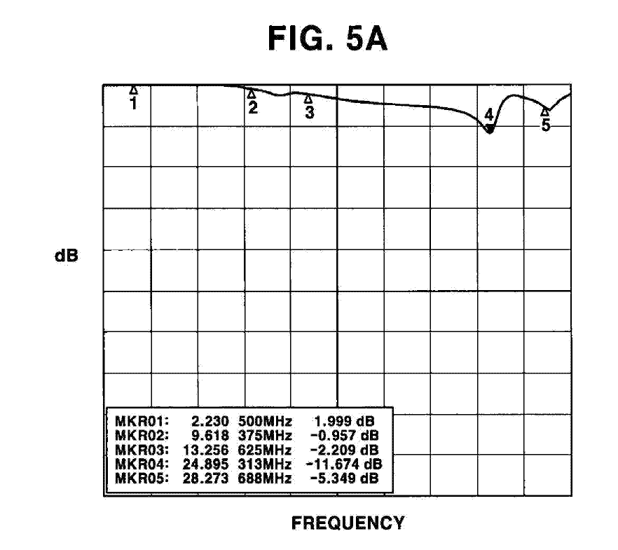

FIG. 4 is a view illustrating an example of PLC signal transmission according to the DIN 70121 standard.

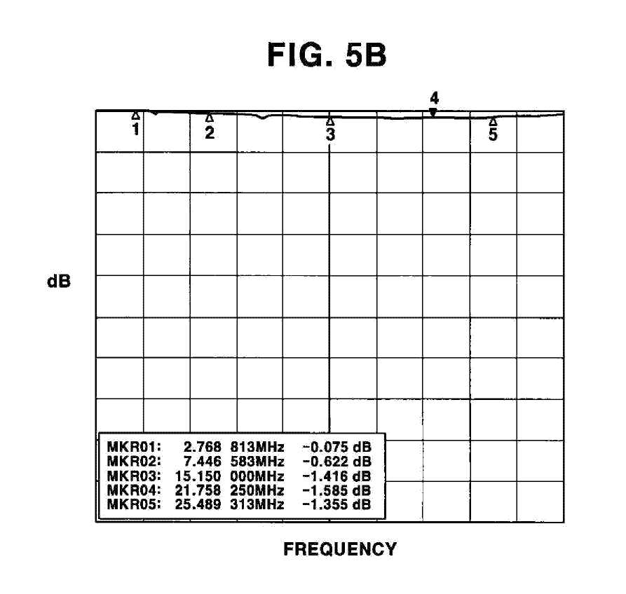

Referring to FIG. 4, the electric vehicle charging system (410) and the electric vehicle (420) may respectively include PLC chipsets (412, 422), which are connected by a PLC signal transmitting line (414) and a ground line (416). The quality of signals can be significantly improved comparing to the conventional power line, when the power line communication cable according to an exemplary embodiment as illustrated in FIG. 1 of the present disclosure is used in a circuit having such structure as illustrated in FIG. 4. The extent of improvement in signal quality may be ascertained in FIG. 5. Other detailed circuits are defined in the standard, which are the same as structures of conventional electric vehicle charging systems and electric vehicles. Therefore, the redundant description therefor will be omitted herein.

FIGS. 5A and 5B are views illustrating a result of signal loss measurement on a PLC signal transmitting line, where FIG. 5A illustrates a case where a conventional power line communication line is used, and FIG. 5B illustrates a case where a power line communication cable according to an exemplary embodiment of the present disclosure is used

Referring to FIGS. 5A and 5B, the conventional power line communication line generated a maximum loss of 11.67 dB. On the contrary, the power line communication cable according to an exemplary embodiment of the present disclosure generated a maximum loss of no more than 1.58 dB.

The abovementioned exemplary embodiments are intended to be illustrative, and not to limit the scope of the claims. Many alternatives, modifications, variations, and equivalents will be apparent to those skilled in the art The features, structures, methods, and other characteristics of the exemplary embodiments described herein may be combined in various ways to obtain additional and/or alternative exemplary embodiments within an equivalent scope. Therefore, the technical scope of the rights for the present disclosure shall be decided by the appended claims and equivalents thereof.

What is claimed is:

1. A power line communication cable for charging an electric vehicle, the power line communication cable comprising:
a PLC signal transmitting line connected to a controller generating a control signal for receiving power; and
a ground line connected to a ground,
wherein the PLC signal transmitting line and the ground line respectively include a single stranded wire, where the PLC signal transmitting line and the ground line are formed in a spiral shape by being mutually intercrossed.

2. The power line communication cable of claim 1, wherein the PLC signal transmitting line is made of a copper material.

3. The power line communication cable of claim 1, wherein the power line communication cable transmits a control signal within a bandwidth of 1.8 MHz to 28 MHz.

4. An electric vehicle charging system supplying electric power to an electric vehicle, the electric vehicle charging system comprising:
a power line supplying electric power required to charge the electric vehicle; and
a PLC line transmitting a signal for controlling charging of the electric vehicle,
wherein the PLC line includes a single-stranded PLC signal transmitting line transmitting a PLC signal and a ground line, where the PLC signal transmitting line and the ground line are formed in a spiral shape by being mutually intercrossed.

5. The electric vehicle charging system of claim 4, wherein the PLC line is made of a copper material.

6. An electric vehicle supplied with electric power from an electric vehicle charging system, the electric vehicle comprising:
a power line port supplied with electric power required to charge the electric vehicle from the electric power charging system; and
a PLC line port receiving a signal for controlling charging of the electric vehicle,
wherein the PLC line port is connected to a power line communication cable formed in a spiral shape including a single-stranded PLC signal transmitting line and a ground line being mutually intercrossed.

7. The electric vehicle of claim 6, wherein the PLC line is made of a copper material.
